(19) United States
(12) Patent Application Publication
(10) Pub. No.: US 2026/0369193 A1
(43) Pub. Date: Nov. 19, 2026

(54) FAULT-TOLERANT OPERATION FOR DISPLAY SYSTEM

(71) Applicant: Tesla, Inc., Austin, TX (US)

(72) Inventors: Edoardo Rundeddu, Mountain View, CA (US); Yiting Huang, Palo Alto, CA (US)

(21) Appl. No.: 19/209,164

(22) Filed: May 15, 2025

(51) Int. Cl. G09G 3/00; G09G 3/20

(52) U.S. Cl. CPC G09G 3/006; G09G 3/2096; G09G 2300/026; G09G 2330/08; G09G 2354/00; G09G 2380/10

(57) ABSTRACT

A display system includes one or more display panels, a first DDIC, a second DDIC, and a controller. The one or more display panels include at least a first display portion and a second display portion. The first DDIC is configured to drive the first display portion and the second DDIC is configured to drive the second display portion. The controller accesses error status information associated with the one or more display panels, the first DDIC, and the second DDIC; and determines a fault associated with the first display portion. In response to the determination, the controller causes higher priority content to be displayed by the second display portion.

### TECHNICAL FIELD

The present disclosure relates to display technology. More particularly, embodiments of the present disclosure relate to systems and methods for enhancing fault tolerance associated with display driver integrated circuits (DDICs) and/or displays.

### BACKGROUND

Display driver integrated circuits (DDICs) can be used for performing video output and touch related functionality across a variety of display panels. In a display system with high resolution or large size display panel(s), multiple DDICs can be cascaded to drive numerous pixels and coordinate touch responses. Improved tolerance to faults associated with DDICs and displays is desired in certain applications.

### SUMMARY OF CERTAIN INVENTIVE ASPECTS

The systems, methods and devices of this disclosure each have several innovative embodiments, no single one of which is solely responsible for all of the desirable attributes disclosed herein. Details of one or more implementations of the subject matter described in this specification are set forth in the accompanying drawings and the description below.

In some aspects, the techniques described herein relate to a display system including: one or more display panels including a first display portion and a second display portion; a plurality of display driver integrated circuits (DDICs) including a first DDIC configured to drive the first display portion and a second DDIC configured to drive the second display portion; and a controller in communication with at least the plurality of DDICs, the controller configured to: access error status information associated with at least the first display portion; detect, based at least in part on the error status information, a fault associated with the first display portion; and in response to detecting the fault associated with the first display portion, cause higher priority content to be displayed by the second display portion, wherein the higher priority content has higher priority than content associated with the second display portion absent the fault.

In some aspects, the techniques described herein relate to a display system, wherein the higher priority content is at least a portion of content associated with the first display portion absent the fault.

In some aspects, the techniques described herein relate to a display system, wherein the higher priority content includes at least one of safety information, operational controls, emergency notification, or navigation and guidance information associated with a vehicle.

In some aspects, the techniques described herein relate to a display system, wherein the controller is further configured to determine that the second display portion is functional prior to causing the higher priority content to be displayed by the second display portion.

In some aspects, the techniques described herein relate to a display system, wherein the plurality of DDICs are arranged in a cascaded configuration.

In some aspects, the techniques described herein relate to a display system, wherein the controller is configured to cause the higher priority content to be displayed by the second display portion by at least: enabling the second DDIC and the second display portion; and disabling at least some remaining DDICs of the plurality of DDICs and at least some remaining display portions of the one or more display panels.

In some aspects, the techniques described herein relate to a display system, wherein the controller is configured to reset the plurality of DDICs prior to disabling the at least some remaining DDICs.

In some aspects, the techniques described herein relate to a display system, wherein the fault is associated with functionality of the first DDIC.

In some aspects, the techniques described herein relate to a display system, wherein the error status information is stored in one or more status registers that are writable by the plurality of DDICs, and wherein the controller accesses the error status information from the one or more status registers.

In some aspects, the techniques described herein relate to a method for controlling one or more display panels and a plurality of display driver integrated circuits (DDICs), the method including: accessing error status information associated with at least a first display portion, the one or more display panels including the first display portion and a second display portion, the plurality of DDICs including a first DDIC and a second DDIC, the first DDIC driving the first display portion and the second DDIC driving the second display portion; detecting, based at least in part on the error status information, a fault associated with the first display portion; and in response to detecting the fault associated with the first display portion, causing higher priority content to be displayed by the second display portion, wherein the higher priority content has higher priority than content associated with the second display portion absent the fault.

In some aspects, the techniques described herein relate to a method, wherein detecting the fault associated with the first display portion includes: enabling each of the plurality of DDICs sequentially for testing.

In some aspects, the techniques described herein relate to a method, wherein the error status information is generated by the plurality of DDICs based on forward error correction (FEC) results.

In some aspects, the techniques described herein relate to a method, wherein causing the higher priority content to be displayed by the second display portion includes: enabling the second DDIC and the second display portion; and disabling remaining DDICs of the plurality of DDICs and remaining display portions of the one or more display panels.

In some aspects, the techniques described herein relate to a method, wherein causing the higher priority content to be displayed by the second display portion further includes: resetting the plurality of DDICs prior to disabling remaining DDICs of the plurality of DDICs and remaining display portions of the one or more display panels.

In some aspects, the techniques described herein relate to a method, wherein enabling the second DDIC and the second display portion includes reconfiguring the second DDIC.

In some aspects, the techniques described herein relate to a method, wherein causing the higher priority content to be displayed by the second display portion: prioritizing the higher priority content over other content associated with the first display portion for displaying on the second display portion.

In some aspects, the techniques described herein relate to a method, wherein the first display portion and the second display portion are display portions of a single display panel.

In some aspects, the techniques described herein relate to a method, further including reconfiguring one or more functional DDICs of the plurality of DDICs to ignore one or more faults associated with one or more faulty DDICs of the plurality of DDICs.

In some aspects, the techniques described herein relate to a method, wherein the higher priority content indicates the fault.

In some aspects, the techniques described herein relate to a method, wherein the higher priority content includes touchable control content that is configured to receive user input.

### BRIEF DESCRIPTION OF THE DRAWINGS

Throughout the drawings, reference numbers are re-used to indicate correspondence between referenced elements. The drawings are provided to illustrate examples of the subject matter described herein and not to limit the scope thereof.

Embodiments of the present disclosure are described with reference to the accompanying drawings, in which like reference characters reference like elements, and wherein:

FIG. 1 depicts an example electric vehicle including at least a display system in which embodiments of the present disclosure can be implemented.

FIG. 2A shows an example block diagram of the display system in accordance with some embodiments of the present disclosure.

FIG. 2B shows an example block diagram of the display system in accordance with some embodiments of the present disclosure.

FIG. 3A and FIG. 3B illustrate example fault detection and user interface content relocation that can be performed by display systems in accordance with some embodiments of the present disclosure.

FIG. 4 is a flow diagram of an example process for providing fault-tolerant operation associated with a display system in accordance with embodiments of the present disclosure.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings. Any suitable principles and advantages of the embodiments disclosed herein can be implemented together with each other.

Generally described, one or more aspects of the present disclosure relate to methods and systems for increasing fault-tolerance associated with display driver integrated circuits (DDICs) and/or displays. More specifically, some embodiments of the present disclosure disclose systems and methods for enhancing fault tolerance of cascaded DDICs and associated display(s) through monitoring error status of DDICs and/or portions of display panels, and reconfiguring DDIC configurations for maintaining at least partial functionality of a display system. Advantageously, reconfiguring DDICs based on error status detection enables a display system to provide or make higher priority user interface content accessible even in the event of a failure.

Display driver integrated circuits (DDICs) can be used for performing video output and touch related functionality across a variety of display panels. In a display system with one or more display panels (e.g., a relatively large display panel), multiple DDICs can be cascaded to drive numerous pixels and coordinate touch responses. In a cascaded configuration, multiple DDICs can be connected in a sequential or series arrangement to collectively drive the large display panel. Each DDIC can control a portion of a panel's source outputs. For touch screen displays, each DDIC can control a portion of touch sensing channels for the panel.

In a cascaded configuration, the failure of a single DDIC or a portion of a display may compromise the overall functionality of the display. For example, a single DDIC malfunction can lead to a cascade of issues. Such issues can include the inability to display video content correctly and/or process touch inputs accurately. However, existing systems with fixed or hard-coded (e.g., using one-time programmable (OTP) memory or pin strap techniques to configure DDIC configurations) cascaded configurations often lack the resilience or flexibility to handle malfunctions or faults associated with DDICs and display panels. For example, due to a hard-coded cascaded configuration, a failure in a single DDIC or a portion of a display panel can lead to missing visual data and/or touch anomalies across the entire display panel. This can be due to operational DDICs (e.g., “healthy” DDICs) still being configured, through hard coded settings, to recognize and synchronize with the faulty DDIC.

To address at least a portion of the above problems, some embodiments of the present disclosure disclose systems and methods for increasing fault tolerance of a display system by detecting failures or other faults of DDICs and associated display(s), and reconfiguring DDICs to disable faulty DDICs and/or faulty portions of display panels while using normally functioning DDICs to provide at least partial display functionality (e.g., displaying higher priority content such as safety related user interface content). In some embodiments, a controller (e.g., a host microcontroller unit (MCU)) can access error status information associated with DDICs to identify a fault associated with a portion of a display, such as a faulty DDIC(s) or a faulty portion of a display panel. The controller can also identify normally functioning DDIC(s) based on the error status information. Based on the identification, the controller can reconfigure DDICs to disable a faulty DDIC, turn off portions of a display that are faulty or affected by the faulty DDIC, and/or enable a normally functioning DDIC to retain video and/or touch control of at least a portion of the display. Advantageously, the controller can enable the display system to operate in a fault-tolerant mode, where higher priority user interface content can be relocated to functioning portion(s) of a display panel to maintain operational safety in a variety of applications, such as automotive displays.

Higher priority user interface content (hereinafter also referred to as “higher priority content”) can generally refer to any information or user interface element that has higher priority than lower priority user interface content (hereinafter also referred to as “lower priority content”). Higher priority content can be content for which uninterrupted access is significant for the operation or safety of a system (e.g., an equipment, a vehicle, a machine, and/or the like). Higher priority content can include safety information, operational controls, emergency notification, navigation and guidance, and/or the like. Higher priority content can be content representing a warning to a user. In the context of a vehicle, higher priority content can include speed, directions, status indicators, warning alerts (e.g., low battery charge), and/or the like associated with the vehicle. In some examples, higher priority content can be provisioned or delivered through an On-Screen Display (OSD) system and/or using static images. In contrast, lower priority content may include information related to entertainment, gaming, and Internet services.

For example, higher priority content can include information (e.g., safety-critical content) related to safe operations of vehicles. More specifically, higher priority content can include information related to vehicle speed, warning lights and alerts (e.g., indicators such as low battery warnings, engine malfunction alerts, and/or tire pressure warnings), blinker status (e.g., turn signal indicators), navigation and guidance (e.g., proximity alerts), and/or the like.

In some examples, when a fault is detected in a portion of a display, a display system can reconfigure a graphical user interface (GUI) to enable display of higher priority content on functional portion(s) of the display. For example, the display system can generate individual GUIs for corresponding higher priority content (e.g., a speedometer GUI for displaying vehicle speed, a warning light GUI for showing active alerts, a blinker status GUI for indicating turn signal activity). The display system can optionally evaluate available area on the functional portion of a display. Based on the size and resolution of the functional area, the display system can determine how many GUIs can be displayed simultaneously. Additionally and/or optionally, the display system can scale and/or arrange GUIs to fit within available display area. For example, if the functional area is smaller, the display system may scale down the GUIs or display content that is of higher priority or more critical (e.g., speed and warning lights). If the functional area is larger, the display system may display additional GUIs or provide a more detailed layout.

As used herein, a DDIC or a portion of a display panel that is normal or functioning normally can refer to the DDIC or the portion of the display panel that is operating as intended without fault, errors, or malfunctions. For example, a DDIC that is functioning normally can perform tasks such as driving pixels, processing touch inputs, or managing data transmission without any deviations from expected behavior and/or in compliance with relevant design specifications.

Although the various aspects will be described in accordance with illustrative embodiments and combinations of features, one skilled in the relevant art will appreciate that the examples and combinations of features are illustrative in nature and should not necessarily be construed as limiting. More specifically, aspects of the present application may be applicable with various types of display systems and/or driver ICs (e.g., display driver integrated circuits (DDICs), touch and display driver integrated circuits (TDDICs) which are a type of DDICs, and/or the like) under different contexts (e.g., associated with a vehicle, a home entertainment system, a multimedia system inside or outside a building). Still further, although specific architectures or configurations of driver ICs and displays for enhanced resilience to faults will be described, such illustrative driver ICs configurations or display system architectures should not be construed as limiting. Accordingly, one skilled in the relevant field of technology will appreciate that the aspects of the present application are not necessarily limited to being applied to any particular types of display systems.

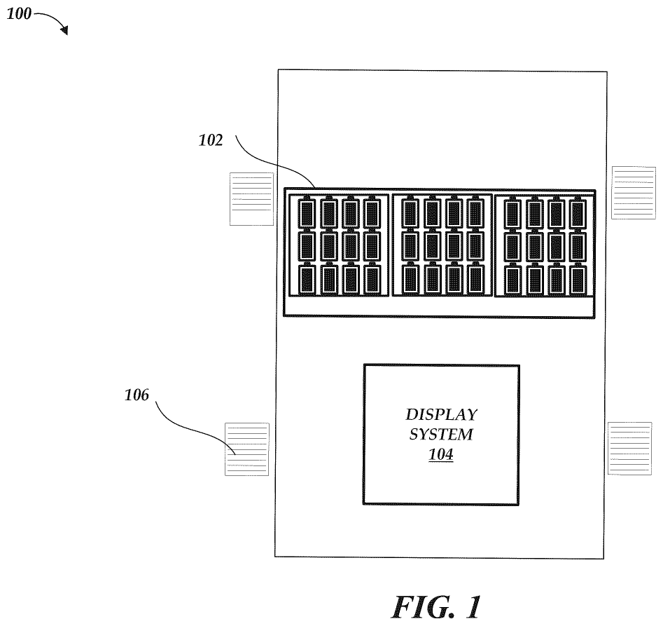

FIG. 1 depicts an example electric vehicle 100 including at least a display system 104 in which embodiments of the present disclosure can be implemented. As shown in FIG. 1, the electric vehicle 100 includes at least battery pack 102, the display system 104, and wheels 106. The battery pack 102 can supply power for operating the electric vehicle 100. The wheels 106 can provide mobility to the electric vehicle 100. The display system 104 can provide visual information to and/or receive user inputs from a user of the electric vehicle 100. Although the example electric vehicle 100 is illustrated in FIG. 1, embodiments of the present disclosure can be implemented in any other suitable context (e.g., in any other types of vehicles, within a building room, in an outdoor setting).

In some examples, the display system 104 can include at least a controller, one or more display panels (e.g., a center display panel and an instrument cluster panel), and multiple DDICs. The DDICs can drive pixels on the one or more display panels. For touch screen display panels, the DDICs can process touch inputs. The DDICs can be deployed in a cascaded configuration to drive the pixels and/or process raw touch data received from touch sensors of the one or more display panels. As noted above, the cascaded configuration can mean that each DDIC controls a respective portion of display(s), and that failure of a DDIC and/or a portion of a display can cause the downstream portion(s) to fail. The DDICs can forward processed touch data or raw touch data to the controller for further processing (e.g., extracting touch coordinates data to facilitate touch display functionality).

In some examples, the display system 104 can enhance fault tolerance associated with the DDICs and the one or more display panels by using the controller to access error status information associated with DDICs and the one or more display panels. Based on the error status information, the controller can reconfigure DDIC configurations for ensuring certain contents can still be presented to a user in the presence of hardware failures or faults associated with the DDICs and/or the one or more display panels.

For example, the controller can access error status information associated with DDICs to determine or identify faulty DDIC(s), faulty portions of display panels, and/or normally functioning DDIC(s). Based on the identification, the controller can reconfigure DDICs to disable a faulty DDIC, turn off portions of a display panel affected by the faulty DDIC, and/or enable a normally functioning DDIC to retain video and/or touch control of at least a portion of the display panel. Advantageously, reconfiguring DDICs based on error status information enables the display system 104 to continue making higher priority user interface content accessible even in the event of a failure associated with a portion of a display, such as a display panel failure or a DDIC failure.

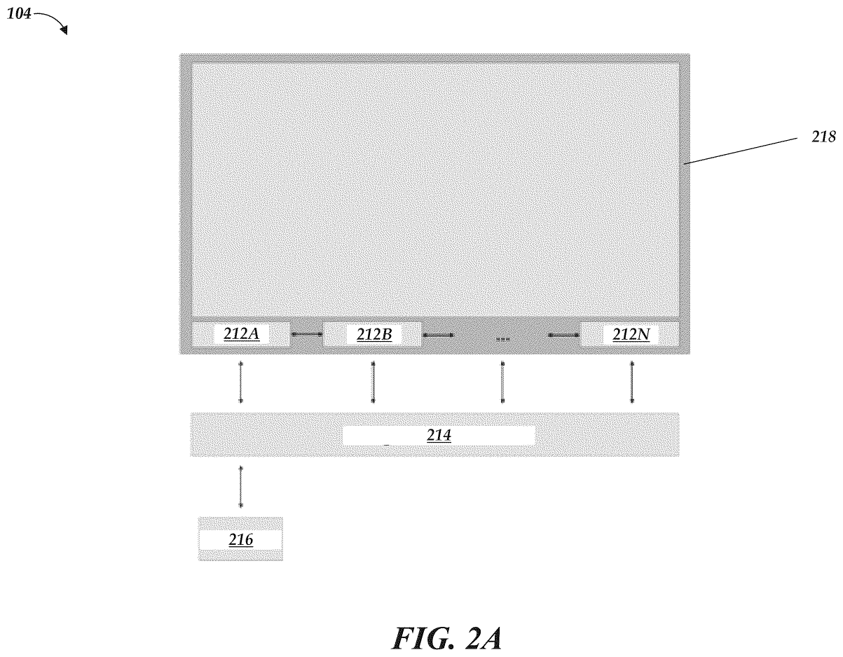

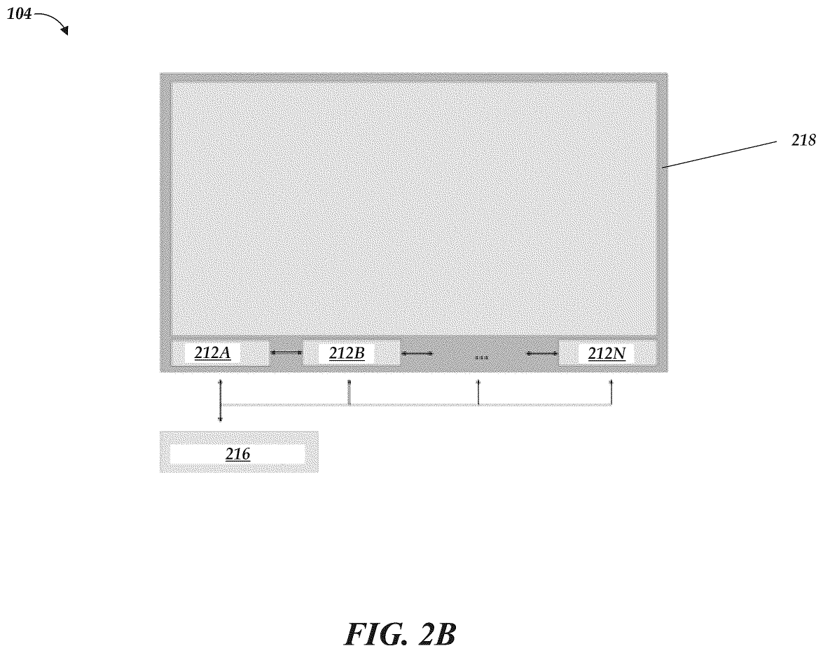

FIG. 2A shows an example block diagram of the display system 104 in accordance with some embodiments of the present disclosure. The display system 104 can be included in a vehicle, such as the electric vehicle 100 of FIG. 1. As shown in FIG. 2A, the display system 104 includes at least a controller 216, a bridge 214, a display panel 218, and DDICs 212A, 212B, through 212N. The display panel 218 can be a liquid crystal display (LCD), an organic light emitting diode (OLED) display, and/or any other suitable type of display. In certain applications, the DDICs 212A, 212B, through 212N can be bonded to glass of the display panel 218.

In some examples, the controller 216 can be embodied as a host microcontroller unit (MCU), a microcontroller, a microprocessor, or any other suitable type of processing circuit. The controller 216 can manage and control operation of the DDICs 212A through 212N and the display panel 218. For example, the controller 216 can process video and touch data for presenting user interface content and/or facilitating touch control through the display panel 218.

In some examples, the bridge 214 can be embodied as a discrete touch MCU, or another suitable type of processing circuit. The bridge 214 can receive raw touch data from the DDICs 212A through 212N and process the raw touch data for the controller 216.

As shown in FIG. 2A, the DDICs 212A through 212N are arranged in a cascaded configuration, where each of the DDICs 212A through 212N can control a corresponding portion of the display panel 218. In some examples, each of the DDICs 212A through 212N can communicate with the bridge 214 and/or the controller 216 through a high-speed video interface and a low-speed serial interface, allowing for efficient data transmission and error status monitoring. For example, the controller 216 can transmit video to the DDICs 212A through 212N using the high-speed video interface and use the low-speed serial interface to access touch data. The high-speed video interface can include a DisplayPort (DP) interface, a high-definition multimedia interface (HDMI), a low-voltage differential signaling (LVDS) interface, or any other suitable interface. The low speed interface can include an inter-integrated circuit (I2C) interface, a serial peripheral interface (SPI), or any other suitable interface.

In some examples, the controller 216 can access (e.g., through a low-speed serial interface) error status information associated with the DDICs 212A through 212N and the display panel 218. The error status information can be generated and/or stored in status register(s) (e.g., one or more registers within and/or external to the DDICs 212A through 212N) by the DDICs 212A through 212N. The error status information can indicate error status and fault(s) internal to the DDICs 212A through 212N and/or related to particular portion(s) of the display panel 218. For example, the error status information can indicate that DDIC 212N is not functioning normally or otherwise failing. More specifically, the error status information can indicate that the DDIC 212N cannot boot up normally or has an internal fault that impedes DDIC 212A and DDIC 212B from booting up normally. As another example, the error status information can indicate that a portion of the display panel 218 corresponding to and controlled by the DDIC 212A has a fault (e.g., some pixels in the portion of the display panel 218 cannot display video normally, a particular region of the portion of the display panel 218 cannot display video normally such as having constantly bright or dark pixels, a touch sensor for the portion of the display panel 218 is not reliably sensing a user touch).

In some examples, based on the error status information, the controller 216 can reconfigure the DDICs 212A through 212N to retain video and/or touch control of at least a portion of the display panel 218. For example, if the error status information indicates that the DDIC 212N is not functioning normally, the controller 216 can disable the DDIC 212N and a portion of the display panel 218 controlled by the DDIC 212N. The controller 216 can further relocate higher priority user interface content associated with the portion of the display panel 218 to other portion(s) of the display panel 218 that are functioning normally. For example, if the error status information indicates that the DDIC 212A is functioning normally, the controller 216 can relocate higher priority user interface content to the portion of the display panel 218 controlled by the DDIC 212A.

FIG. 2B shows an example block diagram of a display system 104 in accordance with some embodiments of the present disclosure. The display system 104 can be included in a vehicle, such as the electric vehicle 100 of FIG. 1. As shown in FIG. 2B, the display system 104 includes at least a controller 216, a display panel 218, and DDICs 212A through 212N. In contrast to the display system 104 of FIG. 2A, in the display system 104 of FIG. 2B the controller 216 can communicate with the DDICs 212A through 212N directly. In some examples, one of the DDICs 212A through 212N (e.g., the DDIC 212A) in the cascaded arrangement shown in FIG. 2B can function as a primary DDIC. In these examples, the controller 216 can communicate with each of the DDICs 212A through 212N, but can read touch coordinates packet from the primary DDIC.

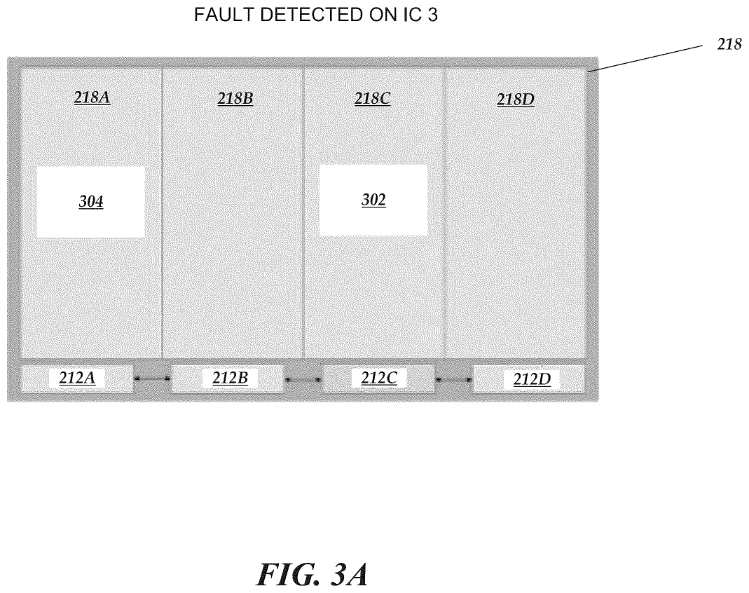

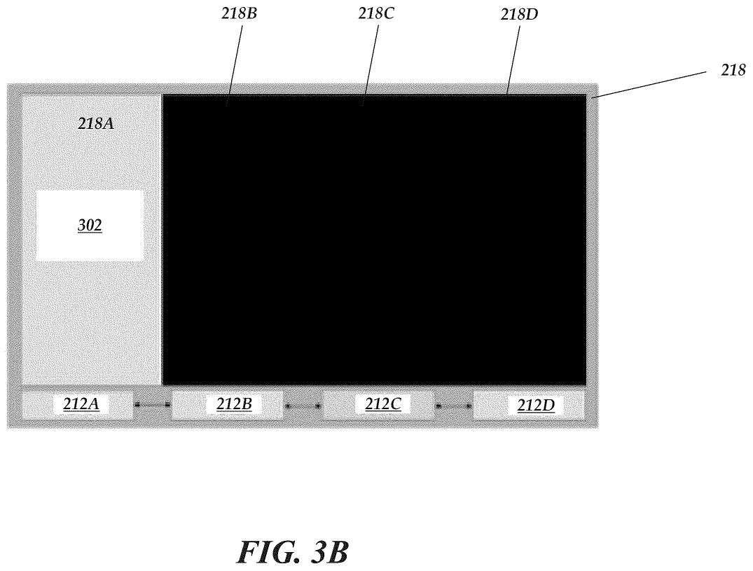

FIG. 3A and FIG. 3B illustrate example fault detection and user interface content relocation that can be performed by a display system 104 in accordance with some embodiments of the present disclosure. As shown in FIG. 3A, the display system 104 can include at least a DDIC 212A, a DDIC 212B, a DDIC 212C, a DDIC 212D, and a display panel 218. The display panel 218 can include a display portion 218A, a display portion 218B, a display portion 218C, and a display portion 218D. Each of the DDIC 212A, the DDIC 212B, the DDIC 212C, and the DDIC 212D can control a respective portion of the display panel 218. For example, the DDIC 212A can control the display portion 218A, the DDIC 212B can control the display portion 218B, the DDIC 212C can control the display portion 218C, and the DDIC 212D can control the display portion 218D. In some other examples, a respective portion of the display panel 218 can be controlled by more than one DDICs. For example, both the DDIC 212A and the DDIC 212B can control the display portion 218B. As indicated in FIG. 3A, content 302 is displayed by the display portion 218C and content 304 is displayed by the display portion 218A. In some examples, the content 302 can be or include higher priority content (e.g., safety information, operational controls, emergency notification, or navigation and guidance information associated with a vehicle). The content 304 can be or include lower priority content (e.g., information related to entertainment, gaming, and Internet services). In some examples, the DDIC 212A, the DDIC 212B, the DDIC 212C, and the DDIC 212D can be arranged in a cascaded configuration.

In operation, the controller 216 can access error status information associated with the DDIC 212A, the DDIC 212B, the DDIC 212C, the DDIC 212D, and the display panel 218. The error status information can be stored in one or more status registers (not shown in FIG. 3A) that can be internal to or external to the DDIC 212A, the DDIC 212B, the DDIC 212C, and/or the DDIC 212D. The error status information can be generated by the DDIC 212A, the DDIC 212B, the DDIC 212C, and/or the DDIC 212D. For example, the DDIC 212B can generate the error status information based on forward error correction (FEC) results generated by a FEC circuitry within the DDIC 212B. More specifically, the FEC circuitry can detect faults associated with the DDIC 212B by processing outputs generated by the DDIC 212B. The error status information can be stored in binary formats including one or more bits to represent various types of faults associated with the DDIC 212A, the DDIC 212B, the DDIC 212C, the DDIC 212D, and the display panel 218.

In some examples, the error status information can indicate a fault associated with the display portion 218C. Such a fault can be related to functionality of the DDIC 212C and/or be related to the functionality of the display portion 218C. For example, the error status information can indicate that the DDIC 212C cannot boot up normally. As another example, the error status information can indicate that a touch sensor associated with the display portion 218C is not properly detecting a user touch event. As yet another example, the error status information can indicate that a particular region of the display portion 218C is not displaying normally (e.g., has constantly dark pixels or bright pixels).

The error status information can also indicate that the DDIC 212A and the display portion 218A are functioning normally (e.g., the DDICs 212A does not have any internal fault, all pixels in the display portion 218A are displaying content correctly). In some examples, based at least in part on the error status information, the controller 216 can determine that the DDIC 212C or the display portion 218C is faulty, and the DDICs 212A and the display portion 218A are functioning normally.

In response to determining that the DDIC 212C or the display portion 218C is faulty, and the DDICs 212A and the display portion 218A are functional (e.g., functioning normally), the controller 216 can cause at least the content 302 (e.g., higher priority content) associated with the display portion 218C to be displayed by the display portion 218A, for example, as illustrated in FIG. 3B. The content 302 can be displayed in place of the content 304 (e.g., lower priority content). The controller 216 can prioritize the content 302 over the content 304 for displaying on the display portion 218A. For example, the controller 216 can prioritize displaying the content 302 over the content 304 based on determining that the content 302 includes higher priority content than the content 304. The controller 216 can be configured to determine that certain higher priority content is displayed by the display panel 218 in the event of detecting a fault and that certain lower priority content is not displayed by the display panel 218 in the event of the fault. The information representing the content 302 can be provided by the controller 216 to the DDIC 212A in response to detecting the fault associated with the display portion 218C, where the content 302 would instead be provided to the DDIC 212C under normal operation.

In some examples, to cause at least the content 302 associated with the display portion 218C under normal operation to be displayed by the display portion 218A, the controller 216 can reconfigure the DDIC 212A, the DDIC 212B, the DDIC 212C, and the DDIC 212D. This can involve arranging the DDICs 212A to 212N in different configuration other than a cascaded configuration. For example, the controller 216 can turn off the DDIC 212C and the display portion 218C and provide the content 302 to the DDIC 212A. As another example, the controller 216 can reconfigure the DDIC 212A, the DDIC 212B, the DDIC 212C, and the DDIC 212D to enable the DDICs 212A and the display portion 218A and disable remaining DDICs (e.g., the DDIC 212B, the DDIC 212C, the DDIC 212D) and remaining display portions (e.g., the display portion 218B, the display portion 218C, and the display portion 218D). In some other examples, the controller 216 can enable more than one DDICs (e.g., the DDIC 212A and the DDIC 212B, or the DDIC 212A and 212D) and more than one display portions (e.g., the display portion 218A and the display portion 218B, or the display portion 218A and the display portion 218D) and disable remaining DDICs and remaining display portions. In some examples, the controller 216 can disable only a faulty DDIC and enable remaining DDICs. In some examples, the controller 216 can disable a faulty DDIC and enable any subset of the remaining DDICs.

In some examples, the controller 216 can reconfigure one or more DDICs that are enabled to ensure system performance. For example, when the controller 216 determines to enable the DDIC 212A and disable the DDIC 212B, the DDIC 212C, and the DDIC 212D, the controller 216 can reconfigure the DDIC 212A. Through reconfiguration, the DDIC 212A can be notified and function based on a new arrangement where the DDIC 212B, the DDIC 212C, and the DDIC 212D are disabled. As such, the DDIC 212A may not generate false alarm or report errors (e.g., to the controller 216) because of a lack of synchronization with the DDIC 212B, the DDIC 212C, and the DDIC 212D that are disabled.

In some examples, the controller 216 can reconfigure the DDIC 212A, the DDIC 212B, the DDIC 212C, and the DDIC 212D into the new configuration other than the cascaded configuration by, for example, setting one or more general purpose input/output (GPIO) pins associated with the DDIC 212A, the DDIC 212B, the DDIC 212C, and the DDIC 212D. For example, by setting certain GPIO pins to high or low states, the controller 216 can disable some of the DDIC 212A, the DDIC 212B, the DDIC 212C, and the DDIC 212D, and/or change connections or configurations associated with the DDIC 212A, the DDIC 212B, the DDIC 212C, and the DDIC 212D. In other examples, the controller 216 can reconfigure the DDIC 212A, the DDIC 212B, the DDIC 212C, and the DDIC 212D by setting one or more one-time programmable (OTP) registers and/or multi-time programmable registers (MTP) associated with one or more of the DDIC 212A, the DDIC 212B, the DDIC 212C, and the DDIC 212D.

Additionally and/or optionally, prior to reconfiguring the DDIC 212A, the DDIC 212B, the DDIC 212C, and the DDIC 212D, the controller 216 can reset the DDIC 212A, the DDIC 212B, the DDIC 212C, and/or the DDIC 212D. For example, the controller 216 can transmit a reset command at least to the DDIC 212A to reinitialize and clear any previous settings associated with the DDIC 212A. As such, the DDIC 212A can start fresh with updated settings and adopt to a new configuration (e.g., with changes in a cascaded arrangement or changes to non-cascaded arrangement, adjustments to video and touch data processing, reallocation of display regions to maintain functionality, and/or the like).

In some other examples not illustrated in FIGS. 3A and 3B, the content associated with the display portion 218A of FIG. 3A can include higher priority content. In these examples, if the controller 216 determines that the DDIC 212C is faulty, the controller 216 can disable the DDIC 212C, and reconfigure one or more of the DDIC 212A, DDIC 212B, and DDIC 212D. As such the DDIC 212A, DDIC 212B, and DDIC 212D can operate in a reduced cascade configuration (e.g., without DDIC 212C cascaded), thereby preventing fault on the DDIC 212C from affecting the capability of the DDIC 212A and/or the display portion 218A to display the higher priority content associated with the display portion 218A.

Although FIGS. 3A and 3B are described with reference to a single display panel 218, any suitable principles and advantages disclosed with reference to these figures can be applied to applications with two or more display panels or two or more displays. For example, a fault can be detected associated with a display portion, and higher priority content can be displayed on a properly functioning second display panel or second display in response to detecting the fault.

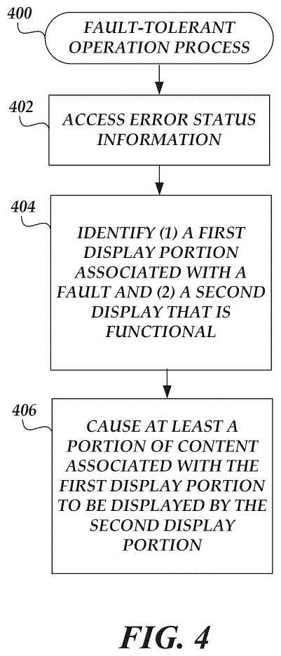

FIG. 4 is a flow diagram of an example fault-tolerant operation process 400 for providing fault-tolerant operation associated with a display system, such as the display system 104 of any of FIGS. 1, 2A, or 2B, in accordance with embodiments of the present disclosure. The process 400 can enable the display system 104 to operate in a fault-tolerant mode, where higher priority user interface content can be relocated to functioning portion(s) of a display panel. This can maintain operational safety in applications, such as automotive displays. The process 400 can be performed by the controller 216.

The process 400 begins at block 402. At block 402, the error status information can be accessed. For example, the controller 216 can access error status information associated with the DDIC 212A, the DDIC 212B, the DDIC 212C, the DDIC 212D, and the display panel 218. The error status information can be stored in one or more status registers that can be internal to and/or external to the DDIC 212A, the DDIC 212B, the DDIC 212C, and the DDIC 212D. The controller 216 can access the one or more status registers to obtain the error status information.

At block 404, the controller 216 can identify or determine, based on the error status information, a first display portion of the display panel 218 associated with a fault and a second display portion of the display panel 218 that is functional. The fault can be faulty DDIC or a fault with functionality of the first display portion. For example, based at least in part on the error status information, the controller 216 can determine that the DDIC 212A and/or the display portion 218A has a fault, and that the DDIC 212D and the display portion 218D are functioning normally. In some examples, the controller 216 can identify or determine faulty DDICs and/or display portions heuristically or based on trial-and-error approaches. For example, the controller 216 can sequentially turn on one of the DDIC 212A, the DDIC 212B, the DDIC 212C, and the DDIC 212D (e.g., while remaining of the DDIC 212A, the DDIC 212B, the DDIC 212C, and the DDIC 212D are turned off). The controller 216 can transmit testing signals to a DDIC that is turned on and analyze responses associated with the DDIC to determine whether the DDIC and/or a display portion associated with the DDIC is faulty. For example, the controller 216 can check whether the DDIC is generating correct or expected video output and/or touch data. By activating each of the DDIC 212A, the DDIC 212B, the DDIC 212C, and the DDIC 212D individually, the controller 216 can isolate and test the functionality of each DDIC and corresponding display portion(s).

At block 406, the controller 216 can cause at least a portion of content associated with a faulty DDIC and/or a faulty display portion under normal operation to be displayed by a normally functioning DDIC and a normally functioning display portion. For example, the controller 216 can cause at least the content 302 associated with the display portion 218C under normal operation (e.g., as shown in FIG. 3A) to be displayed by the display portion 218A (e.g., as shown in FIG. 3B). In some examples, the portion of content caused by the controller 216 to be displayed by the normally functioning DDIC and the normally functioning display portion can include a touchable control used in a touchscreen application. As such, through the normally functioning DDIC and the normally functioning display portion, a user can continue to interact with the touchable control.

In some other examples, the controller 216 can cause display of higher priority content that will not be displayed by the display system 104 when the DDICs 212A, 212B, through 212N and the display panel 218 are fully normally functioning. For example, when detecting any faulty DDIC and/or any faulty display portion, the controller 216 can cause a user warning (e.g., indicating presence of any faulty DDIC and/or faulty display portion) to be displayed by a normally functioning DDIC and a normally functioning display portion. The user warning is not displayed by the display system 104 when the DDICs 212A, 212B, through 212N and the display panel 218 are fully normally functioning.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the example, some acts, events, or functions of any of the algorithms described herein can be performed in a different sequence, can be added, merged, or left out altogether (for example, not all described acts or events are necessary for the practice of the algorithms). Moreover, in some examples, acts or events can be performed concurrently, for example, through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combination of the same, or the like. A processor can include electrical circuitry to process computer-executable instructions. In some examples, a processor includes an FPGA or other programmable device that performs logic operations without processing computer-executable instructions. A processor can also be implemented as a combination of computing devices, for example, a combination of a DSP and a microprocessor, a plurality of microprocessors, microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Conditional language such as, among others, “can,” “could,” “might” or “may,” unless specifically stated otherwise, are otherwise understood within the context as used in general to convey that some examples include, while other examples do not include, some features, elements and/or steps. Thus, such conditional language is not generally intended to imply that features, elements and/or steps are in any way for examples or that examples necessarily include logic for deciding, with or without user input or prompting, whether these features, elements and/or steps are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that some examples require at least one of X, at least one of Y, or at least one of Z to each be present.

Any process descriptions, elements or blocks in the flow diagrams described herein and/or depicted in the attached figures should be understood as potentially representing modules, segments, or portions of code which include executable instructions for implementing specific logical functions or elements in the process. Alternate examples are included within the scope of the examples described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure.

Any process descriptions, elements or blocks in the flow diagrams described herein and/or depicted in the attached figures should be understood as potentially representing modules, segments, or portions of code which include executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

1. A display system comprising:
one or more display panels comprising a first display portion and a second display portion;
a plurality of display driver integrated circuits (DDICs) comprising a first DDIC configured to drive the first display portion and a second DDIC configured to drive the second display portion; and
a controller in communication with at least the plurality of DDICs, the controller configured to:
access error status information associated with at least the first display portion;
detect, based at least in part on the error status information, a fault associated with the first display portion; and
in response to detecting the fault associated with the first display portion,
reconfigure the plurality of DDICs from a cascaded configuration to a non-cascaded configuration, wherein in the non-cascaded configuration at least the first DDIC is disabled; and
cause higher priority content to be displayed by the second display portion, wherein the higher priority content has higher priority than content associated with the second display portion absent the fault.

2. The display system of claim 1, wherein the higher priority content is at least a portion of content associated with the first display portion absent the fault.

3. The display system of claim 1, wherein the higher priority content includes at least one of safety information, operational controls, emergency notification, or navigation and guidance information associated with a vehicle.

4. The display system of claim 1, wherein the controller is further configured to determine that the second display portion is functional prior to causing the higher priority content to be displayed by the second display portion.

5. (canceled)

6. The display system of claim 1, wherein the controller is configured to cause the higher priority content to be displayed by the second display portion by at least:
enabling the second DDIC and the second display portion; and
disabling at least some remaining DDICs of the plurality of DDICs and at least some remaining display portions of the one or more display panels.

7. The display system of claim 6, wherein the controller is configured to reset the plurality of DDICs prior to disabling the at least some remaining DDICs.

8. The display system of claim 1, wherein the fault is associated with functionality of the first DDIC.

9. The display system of claim 1, wherein the error status information is stored in one or more status registers that are writable by the plurality of DDICs, and wherein the controller accesses the error status information from the one or more status registers.

10. A method for controlling one or more display panels and a plurality of display driver integrated circuits (DDICs), the method comprising:
accessing error status information associated with at least a first display portion, the one or more display panels comprising the first display portion and a second display portion, the plurality of DDICs comprising a first DDIC and a second DDIC, the first DDIC driving the first display portion and the second DDIC driving the second display portion;
detecting, based at least in part on the error status information, a fault associated with the first display portion; and
in response to detecting the fault associated with the first display portion,
reconfiguring the plurality of DDICs from a cascaded configuration to a non-cascaded configuration, wherein in the non-cascaded configuration at least the first DDIC is disabled; and
causing higher priority content to be displayed by the second display portion, wherein the higher priority content has higher priority than content associated with the second display portion absent the fault.

11. The method of claim 10, wherein detecting the fault associated with the first display portion comprises:
enabling each of the plurality of DDICs sequentially for testing.

12. The method of claim 10, wherein the error status information is generated by the plurality of DDICs based on forward error correction (FEC) results.

13. The method of claim 10, wherein causing the higher priority content to be displayed by the second display portion comprises:
enabling the second DDIC and the second display portion; and
disabling remaining DDICs of the plurality of DDICs and remaining display portions of the one or more display panels.

14. The method of claim 13, wherein causing the higher priority content to be displayed by the second display portion further comprises:
resetting the plurality of DDICs prior to disabling remaining DDICs of the plurality of DDICs and remaining display portions of the one or more display panels.

15. The method of claim 13, wherein enabling the second DDIC and the second display portion comprises reconfiguring the second DDIC.

16. The method of claim 10, wherein causing the higher priority content to be displayed by the second display portion comprises:
prioritizing the higher priority content over other content associated with the first display portion for displaying on the second display portion.

17. The method of claim 10, wherein the first display portion and the second display portion are display portions of a single display panel.

18. The method of claim 10, further comprising reconfiguring one or more functional DDICs of the plurality of DDICs to ignore one or more faults associated with one or more faulty DDICs of the plurality of DDICs.

19. The method of claim 10, wherein the higher priority content indicates the fault.

20. The method of claim 10, wherein the higher priority content comprises touchable control content that is configured to receive user input.
